(19) United States
(12) Patent Application Publication
(10) Pub. No.: US 2006/0230031 A1
(43) Pub. Date: Oct. 12, 2006

(54) Document searching device, document searching method, program, and recording medium

(76) Inventors: Tetsuya Ikeda, Tokyo (JP); Takuya Hiraoka, Tokyo (JP); Hiroki Hayano, Tokyo (JP); Shiro Horibe, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/395,731

(22) Filed: Mar. 31, 2006

(30) Foreign Application Priority Data
Apr. 1, 2005 (JP) 2005-106886
Nov. 7, 2005 (JP) 2005-322793
Feb. 24, 2006 (JP) 2006-049066

(51) Int. Cl. G06F 17/30

(52) U.S. Cl. 707/3

(57) ABSTRACT

In a document searching device that searches documents from a set of predetermined documents in response to an input search condition, a seed document acquiring unit is operable to acquire seed documents based on information that is different from the input search condition. A word extraction unit is operable to extract a set of words that are associated with the input search condition, from the seed documents acquired by the seed document acquiring unit. A search unit is operable to search documents from the set of predetermined documents based on the input search condition and the set of words extracted by the word extraction unit.

The present application claims priority to and incorporates by reference the entire contents of Japanese priority document 2005-106886, filed in Japan on Apr. 1, 2005; 2005-322793, filed in Japan on Nov. 7, 2005; and 2006-049066;, filed in Japan on Feb. 24, 2006.

### BACKGROUND OF THE INVENTION

1. Field of the Invention

The present invention generally relates to a document searching device, a document searching method, a computer-readable program, and a recording medium. More particularly, the present invention relates to a document searching device, a document searching method, a computer-readable program, and a recording medium which search a document from a set of given documents in response to an input search request with search conditions.

2. Description of the Related Art

In the field of a document searching, one of the important evaluation criteria is whether search results match a user's search request. Conventionally, a document searching device is proposed in which a degree of matching (or degree of conformity) of each document with the search request is determined based on the search words specified in the search request, and with which a degree of conformity outputs the search results are outputted in descending order of the degrees of conformity of the documents. For example, refer to Japanese Laid-Open Patent Application No. 11-224264.

The quality of search results is estimated by using an average conformity ratio or the like. The average conformity ratio is calculated as follows. The ratio (or conformity ratio) of the conforming documents (documents which match the search request) to the higher-rank “n” documents contained in a list of search results is calculated for each of n=1, 2, - - - , N, respectively, and the values of these N conformity ratios are averaged to determine the average conformity ratio.

In order to obtain the search results with high quality, the related term extension method is proposed. In the related term extension method, the related term is also added as a search word not only with the search word which is specified in the search request by the user.

Moreover, there are various proposed methods that are related to the method of selection of the search word (extension word) which is added by the related term extension method.

For example, the conformity feedback method is known. The system in the conformity feedback method first presents to the user the result of the search (primary search) using the search word specified by the user, and then the user classifies the result of the primary search into conforming documents and non-conforming documents. The system obtains the user's classification result and outputs the result of the search (secondary search) using the extension word chosen from the words contained in the conforming documents as a final result.

In the following, the documents used for choosing the extension word will be called seed documents.

In order to ease the burden that is forced on the user by the conformity feedback method, the pseudo conformity feedback method is proposed. In the pseudo conformity feedback method, the extension word is obtained by using as seed documents the high-rank document in the result of the primary search.

However, in the conventional conformity feedback method and pseudo conformity feedback method, the prerequisite is that a seed document is chosen from the documents that are searched based on the search word, and selection of the extension word is affected by the composition of the documents of the searching embodiment.

Some methods are proposed to,overcome the above problem. For example, Japanese Laid-Open Patent Application No. 2003-242170 discloses a method in which the result of calculation of the degree of conformity of the primary search is merged into calculation of the degree of conformity of the secondary search, and, even if the quality of the primary search is low, the influence of the quality on the final result can be reduced.

Moreover, Japanese Laid-Open Patent Application No. 2004-192374 discloses the method in which the seed document is divided based on bibliographic items, such as the author and the date, so that an extension word can be chosen from various viewpoints.

In either of the two methods mentioned above, the common processing in which the seed document is specified is performed, and one of the methods may be selected according to a particular use. However, the selection of the seed document is performed by the system, and each composition of the two methods is used properly by the system. And the two methods mentioned above have a difficulty in respect of the ease of using.

On the other hand, another method is also proposed in which the related words are registered beforehand for every word, and the related term extension is performed based on the correspondence relation. For example, Japanese Laid-Open Patent Application No. 2003-022275 discloses the method in which the related words are registering in the form of a common word database.

However, in the case of the method in which the correspondence relations are registered beforehand, maintenance of the correspondence relations is needed, and there is a problem that the application of such a method is difficult in the field in which new words are added continuously one after another.

### SUMMARY OF THE INVENTION

A document searching device, document searching method, program, and recording medium are described. In one embodiment, a document searching device that searches documents from a set of predetermined documents in response to an input search condition, comprises a seed document acquiring unit to acquire seed documents based on information that is different from the input search condition, a word extraction unit to extract a set of words which are associated with the input search condition, from the seed documents acquired by the seed document acquiring unit, and a search unit to search documents from the set of predetermined documents based on the input search condition and the set of words extracted by the word extraction unit.

### BRIEF DESCRIPTION OF THE DRAWINGS

Other embodiments, features and advantages of the present invention will be apparent from the following detailed description when reading in conjunction with the accompanying drawings.

FIG. 1 is a diagram showing the functional composition of a document management system in an embodiment of the invention.

FIG. 2 is a diagram showing the hardware composition of the document management system in an embodiment of the invention.

FIG. 3 is a flowchart for illustrating the document-searching processing performed by the document management system in an embodiment of the invention.

FIG. 4 is a diagram showing an example of a search request input display screen.

### DETAILED DESCRIPTION

Embodiments of the present invention comprises an improved document searching device and method in which the above-described problems are eliminated.

Other embodiments of the present invention comprise a document searching device, a document searching method, a computer-readable program, and a recording medium which can output appropriate search results in response to a search request input with search conditions.

In order to achieve the above-mentioned embodiments, the present invention includes a document searching device that searches documents from a set of predetermined documents in response to an input search condition, the document searching device comprising: a seed document acquiring unit to acquire seed documents based on information that is different from the input search condition; a word extraction unit to extract a set of words which are associated with the input search condition, from the seed documents acquired by the seed document acquiring unit; and a search unit to search documents from the set of predetermined documents based on the input search condition and the set of words extracted by the word extraction unit.

In order to achieve the above-mentioned embodiments, the present invention includes a document searching method which which is performed by a document searching device comprising a search unit searching documents from a set of predetermined documents in response to an input search condition, a seed document acquiring unit acquiring seed documents used for the search unit, and a word extraction unit to extract a set of words from the seed documents, the document searching method comprising: a seed document acquisition operation causing the seed document acquiring unit to acquire seed documents based on information different from the input search condition; a word extraction operation causing the word extraction unit to extract a set of words which are associated with the input search condition, from the seed documents acquired in the seed document acquisition operation; and a search operation causing the search unit to search documents from the set of predetermined documents, based on the input search condition and the set of words extracted in the word extraction operation.

According to the present invention, it is possible to provide the document searching device, the document searching method, the computer-readable program, and the recording medium which can output appropriate search results in response to an input search request with search conditions.

A description will now be given of an embodiment of the invention with reference to the accompanying drawings.

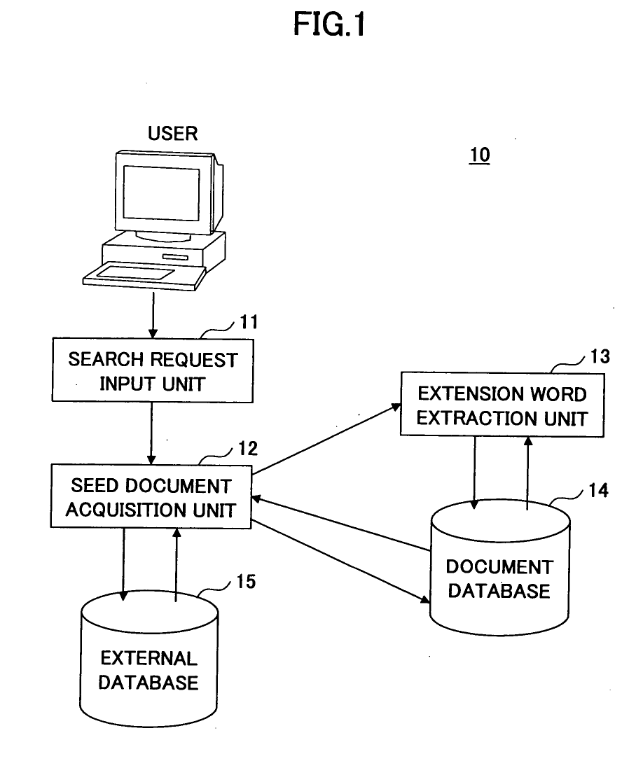

FIG. 1 shows the functional composition of the document management system in an embodiment of the invention.

As shown in FIG. 1, the document management system 10 comprises a search request input unit 11, a seed document acquisition unit 12, an extension word extraction unit 13, and a document database unit 14.

The search request input unit 11 causes a user to input search conditions used in the document searching, as well as a character string for acquiring seed documents used in the related term extension.

The seed document acquisition unit 12 acquires or searches seed documents based on the input character string which is received by the search request input unit 11.

The extension word extraction unit 13 selects a predetermined number of extension words from among the words that constitute the seed document acquired by the seed document acquisition unit 12.

The document database unit 14 uses the input search conditions and the extension words selected by the extension word extraction unit 13, to search documents that match the search conditions and the extension words, among a set of documents stored in the document database unit 14, and provides the user with a list of search results.

The related term extension means the method in which the related words which are separate from the search words contained in the search conditions are also added as the search words, in order to obtain the search results of high quality. The search words added by the related term extension are called extension words, and the document used for selecting or extracting the extension words is called a seed document.

The external database 15 is an example of a document database in a system which is different from the document management system 10.

The above-mentioned document management system 10 may comprise a computer. Alternatively, a client-server system may be used to implement the document management system 10. In such an alternative embodiment, the document management system 10 may be implemented by two or more computers. In such a case, for example, the search request input unit 11 may be installed in a client computer of a client-server system, and the seed document acquisition unit 12, the extension word extraction unit 13, and the document database unit 14 may be installed in a server computer of the client-server system.

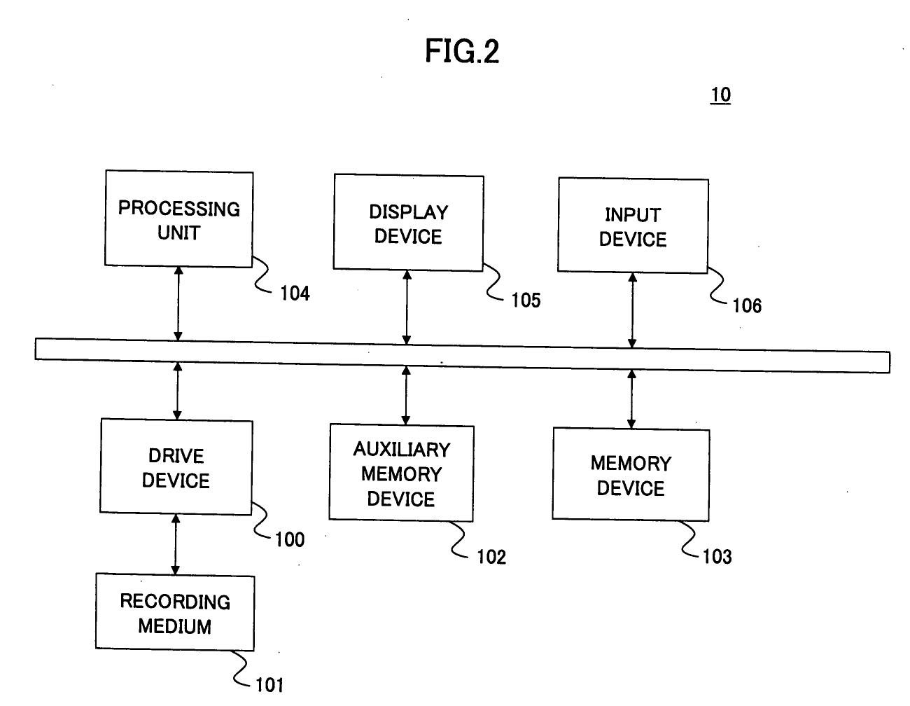

FIG. 2 shows the hardware composition of the document management system in an embodiment of the invention.

The document management system 10 of FIG. 2 comprises a drive device 100, an auxiliary memory device 102, a memory device 103, a processing unit 104, a display device 105, and an input device 106, which are interconnected by the bus.

The program that causes the processing to be performed by the document management system 10 is installed with a recording medium 101, such as a CD-ROM. When the recording medium 101 in which the program is recorded is set in the drive device 100, the program from the recording medium 101 is installed in the auxiliary memory device 102 through the drive device 100. In the auxiliary memory device 102, the installed program is stored, and the necessary files and data are also stored.

When a processing start command is received, the program is read from the auxiliary memory device 102 and stored into the memory device 103.

The processing unit 104 performs the functions related to the document management system 10, in accordance with the program stored in the memory device 103. The display device 105 displays the GUI (Graphical User Interface) in accordance with the program. The input device 106 comprises a keyboard, a mouse, etc. and used to receive various operational commands.

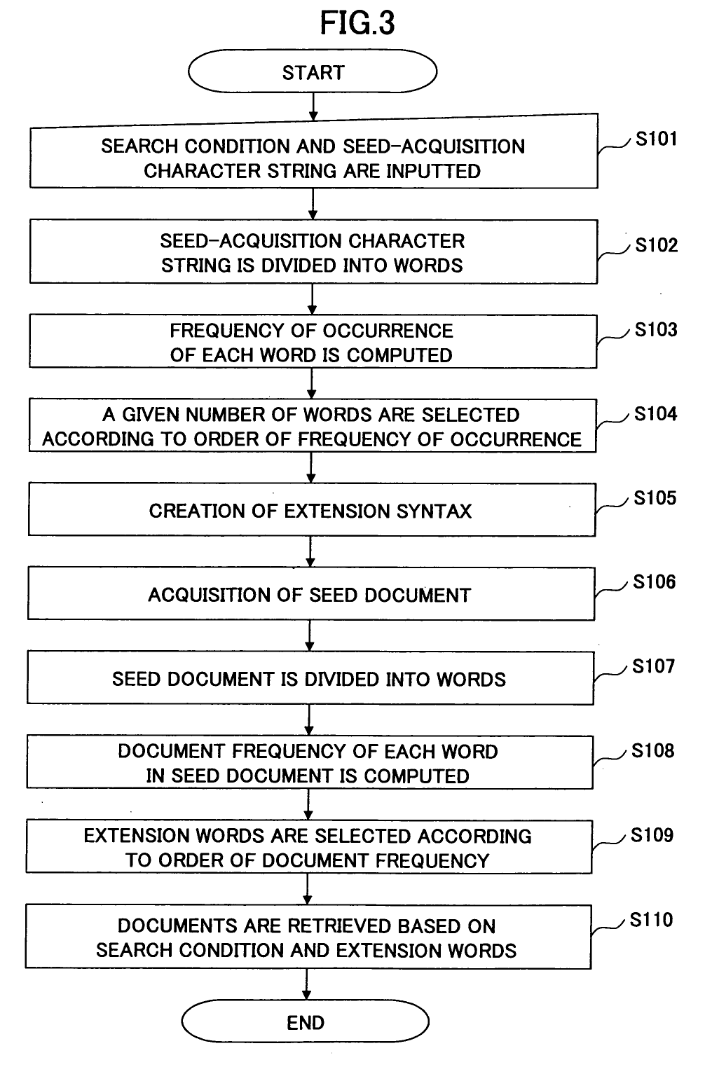

The step of the document management system 10 will be explained with reference to FIG. 1 and FIG. 2. FIG. 3 is a flowchart for illustrating the document-searching processing that is performed by the document management system in an embodiment of the invention.

Upon the start of the document-searching processing, the search request input unit 11 displays the screen for requesting the user to input a search request (where screen is referred to herein as a search request input display screen), on the display device 105, and causes the user to input a search request (step S101).

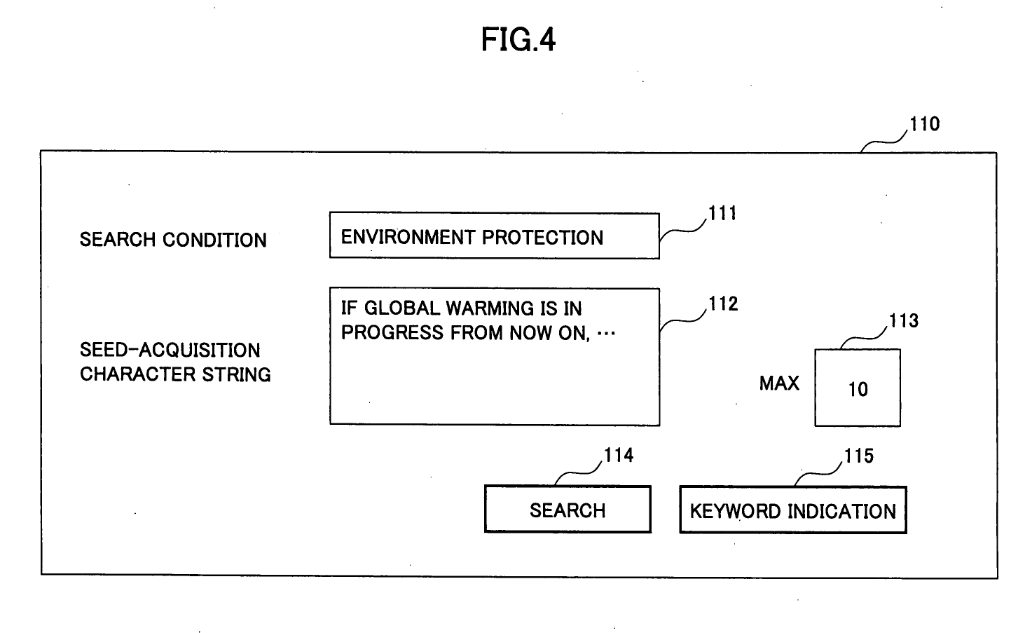

FIG. 4 shows an example of the search request input display screen. As shown in FIG. 4, the search request input display screen 110 includes a search condition input area 111, a seed-acquisition character string input area 112, a seed-number input area 113, a search button 114, and a keyword indication button 115.

The search condition input area 111 is a text box for allowing the user to input a search condition. A predetermined conditional formula and a predetermined search word can be input as the search condition. The seed-acquisition character string input area 112 is a text box for allowing the user to input a character string (a word, a compound, or a text) used for acquiring or searching seed documents. The character string input at this time will be called seed acquisition character string.

The seed-number input area 113 is a text box for allowing the user to input the maximum number of seed documents. The keyword indication button 115 is a button for displaying the dialog for allowing the user to choose the keyword used for the search condition or the seed acquisition character string.

When the user inputs the search condition, the seed acquisition character string, and the maximum number of seed documents and clicks the search button 114, the control will progress to step S102.

In the step S102, the search request input unit 11 divides the seed acquisition character string (which is input to the search request input display screen 110) into words. The division of the seed acquisition character string into words may be performed by using the known syntactic analysis. Then, the search request input unit 11 computes the frequency of occurrence (for example, the number of occurrences of the word) in the seed acquisition character string of each word contained in the seed acquisition character string (S103).

Then, the search request input unit 11 selects a given number of high-rank words arranged in a descending order of the frequency of occurrence (S104). The search request input unit 11 creates the command statement which contains the search request being sent to the document database unit 14, based on the selected words, the maximum number of seed documents and the search condition which are input into the search request input display screen 110 (S105).

The command statement that contains the search request may be created by using the known SQL syntax or its extension syntax. For example, the extension syntax using a sub-query may be used. Such example is given below:

select title from Documents where data contains ‘environment protection’ . . . (1)

expand from (select data from Documents where data contains ‘warming’ limit 10) . . . (2)

The select statement contained in the command statement (1) is a search command from the table ‘Documents’ defined in the document database unit 14. Specifically, this command is for searching the value of title item (title of a document) of a record that contains the word ‘environment protection’ in data item (text of the document) in the Documents table.

The sub-query following the description ‘expand from . . . ’ which is contained in the command statement (2) is a search command for acquiring seed documents. Specifically, this search command is for searching the ten high-rank data items of records that contain the word ‘warming’ in data item in the Documents table.

The ranking that defines the ten high-rank data is determined based on the degree of conformity of each document, for example. The keyword ‘warming’ is the word extracted from the seed acquisition character string, and the ‘limit 10’ indicates the maximum number of seed documents. The word ‘environment protection’ is the search word input as the search condition.

The user may be requested to explicitly input the command statements contained in (1) and (2). However, from a viewpoint of the convenience of the user who is unfamiliar with the SQL syntax, it is preferred that a GUI (Graphical User Interface), such as the search request input display screen 110, is provided to cause the system to automatically create the command statement.

Then, the seed document acquisition unit 12 acquires seed documents from the document database unit 14 or the external database 15 based on the command statement (2) created by the search request input unit 11 (S106).

In the above-mentioned example, the sub-query ‘select data from Documents where data contains ‘warming’ limit 10’ (2) is sent to the document database unit 14, so that the values of the ten high-rank data items of the documents are acquired from among the documents which match the keyword ‘warming’ as the seed documents.

Then, the extension word extraction unit 13 determines that the seed documents acquired by the seed document acquisition unit 12 are conforming documents, and performs extraction and selection of extension words as the processing corresponding to the expand phrase.

Namely, the extension word extraction unit 13 divides the seed documents into words (S107). And the extension word extraction unit 13 computes the document frequency of each word (S108). In this case, the document frequency of the word ‘W’ is the number of the seed documents which contain the word ‘W’.

The extension word extraction unit 13 selects a given number of high-rank words arranged in descending order of the document frequency, and determines the selected words as being extension words (S109).

The division into words of the seed documents may be performed by using the unit separated by the blank. Alternatively, it may be performed by using the known morphological analysis. Alternatively, it may be performed simply by using a fixed number of characters.

Moreover, the mechanism may be implemented in the system so that the inappropriate words for the search words are beforehand registered, and even when the document frequency is high, the words which are registered as the inappropriate words are not selected as the extension words. The number of the extension words being extracted may be fixed by the system. Alternatively, the search request input unit 11 may request the user to specify the number of the extension words through a GUI or the like.

Progressing to step S110 following step S109, the document database unit 14 uses the search conditions (search words) input to the search request input display screen 110 and the extension words extracted by the extension word extraction unit 13, and searches the documents that contain the search conditions and all or separately of the extension words, from among the set of documents in the document database unit 14. The document database unit 14 provides the user with the list of search results.

For example, the processing by the document database unit 14 may be performed by using the method disclosed in Japanese Laid-Open Patent Application No. 2003-281181.

According to the document management system 10 of the above-described embodiment, the extension words are selected based on the character string specified by the user, and it is possible to output high quality search results which are in conformity with the input search request intended by the user.

Since the seed acquisition character string can be input by the user concurrently with the input of the search condition, the user can obtain high quality search results easily by performing a single input operation.

Next, a second embodiment of the invention will be explained. In this embodiment, the seed documents are acquired from a set of documents that are different from the set of given documents from which documents of the searching object are searched.

In the present embodiment, the functional composition (FIG. 1) of the document management system 10, the hardware composition of the document management system 10 (FIG. 2), and the document-searching processing performed by the document management system 10 (FIG. 3) are essentially the same as those of the previous embodiment mentioned above, and a description thereof will be omitted.

In the present embodiment, the search request input unit 11 creates, in the step S105 of the processing of FIG. 3, the following command statement as the command statement that contains the search request being sent to the document database unit 14. Namely, in the extension syntax using the sub-query in the previous embodiment, another table that is different from the table of the searching object is specified as the searching embodiment for the sub-query in this object. An example of the command statement created in the step S105 is given as follows:

select title from Documents where data contains ‘environment protection’ . . . (1)

expand from (select headline from MyFavoriteNews where headline like ‘% environment %’) . . . (3)

The sub-query following the description “expand from”, which is contained in the command statement (3) is given to indicate that the table “MyFavoriteNews” which stores a set of documents different from the set of the given documents stored in the table “Documents” should be used as the searching object, and means the command statement that is to ‘search the values of headline items of the records which contain in their headline items the character string ‘environment’.

Therefore, in this case, the values of the headline items of the records searched from the MyFavoriteNews table are used as the seed documents, and then the subsequent steps S106 to S110 in the processing of FIG. 3 are performed similarly.

Data addition, deletion and change of the MyFavoriteNews table are performed independently of the Documents table which is of the searching object, and the selection of seed documents is not influenced by the contents of the Documents table.

The documents stored in the MyFavoriteNews table may be acquired from the external device outside the document management system 10. For example, the MyFavoriteNews table may be constituted by a set of documents which the user has found on the WWW (World Wide Web). In such a case, regardless of the contents of the Documents table, the selection of extension words is performed by using the contents of documents in that the user is interested.

Therefore, even when the information in which the user is not interested is contained in the Documents table, the selection of extension words is not influenced by the contents of the Documents table. Therefore, it is possible to increase the possibility of outputting the search results that are in conformity with the user's demand.

Next, a third embodiment of the invention will be explained. In this embodiment, the functional composition (FIG. 1) of the document management system 10, the hardware composition of the document management system 10 (FIG. 2), and the document-searching processing performed by the document management system 10 (FIG. 3) are essentially the same as those of the previous embodiment mentioned above, and a description thereof will be omitted.

In the present embodiment, the search request input unit 11 creates, in the step S105 of the processing of FIG. 3, the following command statement as the command statement that contains the search request being sent to the document database unit 14. Namely, in addition to the extension syntax used in the sub-query in the previously described first embodiment, additional extension syntax is specified for use in the sub-query of this embodiment. An example of the additional extension syntax is given as follows:

select title from Documents where data contains ‘environment

protection’ ... (1)

expand from (

select data from Documents where data contains ‘carbon

dioxide’

expand from (

select headline from

RecentNews where headline like ‘%warming%’ limit 10) ... (5)

limit 20) ... (4)

In this example, the twenty higher-rank items of the search results according to the command statement (4) are used for the seed documents which are used for extracting the extension words in the searching processing based on ‘environment protection’ according to the command statement (1). Moreover, in the searching of the seed documents based on ‘carbon dioxide’, the extension words are added with which the values of the headline items of the ten higher-rank items of the records which contain ‘warming’ in their headline items are extracted from the RecentNews table as the seed documents.

Accordingly, the search results in which the words that constitute the documents which contain ‘warming’ are additionally used as the extension words are used as the seed documents, and it is possible to obtain more appropriate extension words in the present embodiment, when compared with the case in which the search results based on ‘carbon dioxide’ only are used as the seed documents.

In this manner, by using the nesting of the sub-queries, it is possible to perform the searching that is like the pseudo conformity feedback is performed at least twice, in response to a single search request. The nesting of the sub-queries may be configured to be more than duplex.

Next, a fourth embodiment of the invention will be explained. In this embodiment, the functional composition (FIG. 1) of the document management system 10, the hardware composition of the document management system 10 (FIG. 2), and the document-searching processing performed by the document management system 10 (FIG. 3) are essentially the same as those of the previous embodiment mentioned above, and a description thereof will be omitted.

In the present embodiment, the search request input unit 11 creates, in the step S105 of the processing of FIG. 3, the following command statement as the command statement that contains the search request being sent to the document database unit 14. Namely, in the extension syntax using the sub-query in the previously described first embodiment, the search condition related to bibliographic items is specified as the sub-query in this embodiment. An example of the command statement in this embodiment is given as follows:

select title from Documents where data contains ‘environment

protection’

expand from (

select data from Documents

where title like ‘%efforts%’
and author like ‘%RRRR%’
and publish_date >=
‘2004/10/01’ limit 20)

In this example, the documents that are used as the seed documents which are used to extract the extension words for use in the searching based on ‘environment protection’ are the higher-rank 20 documents among the documents which contain in their title items ‘efforts’, contain in their author items ‘RRRR’, and contain in their publish_date items a date of publication on and after Oct. 1, 2004.

According to the present embodiment, the extension words can be chosen from the documents to which the criteria different from the search request to the documents of the searching object are taken into consideration. Therefore, it is possible for the present embodiment to output high quality search results that taken into consideration the feedback based on various viewpoints.

Next, a fifth embodiment of the invention will be explained. In this embodiment, the functional composition (FIG. 1) of the document management system 10, the hardware composition of the document management system 10 (FIG. 2), and the document-searching processing performed by the document management system 10 (FIG. 3) are essentially the same as those of the previous embodiment mentioned above, and a description thereof will be omitted.

In the present embodiment, the search request input unit 11 creates, in the step S105 of the processing of FIG. 3, the following command statement as the command statement which contains the search request being sent to the document database unit 14. Namely, the sub-query is created by including a set of character strings in the extension syntax used in the sub-query in the previously described first embodiment. An example of the command statement in this embodiment is given as follows:

select title from Documents where data contains ‘environment

protection’

expand from (
values (‘recent trend of global warming --’, ′Kyoto Protocol --′, ′-

-′, --))

In this example, the set of character strings specified in the “values ( )” of the above command statement are used directly as the seed documents for extracting the extension words for use in the searching of ‘environment protection’. For example, that which is input into the seed acquisition character string input area 112 of the search request input display screen 110 may be used as these character strings. In such a case, it becomes unnecessary to perform the steps S102 to S105 in the processing of FIG. 3, and the step S106 may be configured so that the seed document acquisition unit 12 acquires the seed documents by receiving each of the character strings input into the seed acquisition character string input area 112 and using each as one of the seed documents.

According to the document management system 10 in the present embodiment, it is possible to perform the searching by using directly as the seed documents the character strings specified by the user at the time of inputting of the search request. Therefore, it is possible to perform the related term extension method without being influenced by the documents of the searching object. For example, it becomes easy to perform the document searching in which the extension words are extracted using all or a part of the documents obtained through the searching on the WWW (World Wide Web).

Next, a sixth embodiment of the invention will be explained. In this embodiment, the functional composition (FIG. 1) of the document management system 10, the hardware composition of the document management system 10 (FIG. 2), and the document-searching processing performed by the document management system 10 (FIG. 3) are essentially the same as those of the previous embodiment mentioned above, and a description thereof will be omitted.

In the present embodiment, the search request input unit 11 is configured so that the user is requested to input search conditions, and the search request input unit 11 searches or acquires the character string for acquiring the seed documents for use in the related term extension, based on the input search conditions.

Alternatively, the character string for acquiring the seed documents may be acquired by causing the user to input the character string concurrently with the time of inputting the search conditions.

Therefore, the character string with the highest degree of conformity among the search results obtained based on the search conditions input into the search condition input area 111 may be automatically input into the seed acquisition character string input area 112 of the search request input display screen 110 (FIG. 4). Alternatively, that which is arbitrarily chosen by the user from among the search results obtained based on the search conditions input into the search condition input area 111 may be input into the seed acquisition character string input area 112. Otherwise, the character string that is arbitrarily input by the user separately from the search conditions may be input.

The seed document acquisition unit 12 in this embodiment acquires or searches the seed documents based on the seed acquisition character string acquired by the search request input unit 11. Specifically, the seed document acquisition unit 12 performs the primary search based on the character string for acquiring the seed documents, acquired by the search request input unit 11, and acquires or searches the seed documents that have a given attribute which is common to that of the documents obtained through the primary search. The given attribute is optional and not limited to a particular one, if it is expected to obtain the documents appropriate as the seed documents. For example, the information that contains the source of each document including an author, a publishing company, or a translator may be satisfactory for this purpose.

The extension word extraction unit 13 in this embodiment selects a predetermined number of extension words from among the words that constitute the seed documents. The document database unit 14 uses the input search conditions and the extension words selected by the extension word extraction unit 13, searches documents that match the search conditions and the extension words, among the set of given documents stored in the document database unit 14, and provides the user with a list of search results.

The external database 15 is an example of a document database in a system which is different from the document management system 10.

Next, the document-searching proceeding performed by the document management system 10 in the present embodiment will be explained. In this embodiment, the document-searching processing performed by the document management system 10 is essentially the same as that of the previously described first embodiment shown in FIG. 3.

However, in the present embodiment, the search request input unit 11 creates, in the step S105 of the processing of FIG. 3, the following command statement as the command statement which contains the search request being sent to the document database unit 14.

select title from Documents where title contains ‘environment protection’ . . . (1)

expand from (select title from Documents where ‘given attribute’ in . . . (6)

(select ‘given-attribute’ from Documents where title contains ‘warming’ limit 10)) . . . (7)

The select statement contained in the above command statement (1) is a search command to select the title from the table ‘Documents’ defined in the document database unit 14 as mentioned above. Specifically, the search command is for searching the values of title items (titles of documents) of the records that contain in their title items the words ‘environment protection’ in the Documents table.

The outside select statement in the sub-query following the description “expand from”, which is contained in the above statement (6) is a select command for acquiring a larger number of seed documents. Specifically, the select command is for searching the title items of the records that have the value of the given attribute in the Documents table which matches the value of the search results of the above statement (7).

The inside select statement in the sub-query following the description “expand from”, which is contained in the above statement (7) is a search command for acquiring the seed documents. Specifically, the select command is to search the title items of the high-rank ten documents of the records which contain the word ‘warming’ in their title items in the Documents table. The ranking which defines the high-rank ten documents is performed based on the degree of conformity of each document, for example.

The keyword ‘warming’ is the word extracted from the seed acquisition character string. The ‘limit 10’ means the maximum number of seed documents being obtained. The words ‘environment protection’ are the search words which are input as the search conditions.

In the above-mentioned SQL syntax, the documents that have the value of the given attribute common to that of the documents searched in the statement (7) are searched by the statement (6). The search results are used as the seed documents for the extraction of extension words. Thus, it is possible for the present embodiment to obtain a larger number of seed documents than the number of seed documents obtained in the case in which only the documents searched by the statement (7) are used as the seed documents.

Alternatively, the document-searching processing may be configured so that the user is requested to input explicitly the command statements as indicated by the above statements (1) and (6). However, from the viewpoint of convenience for the user who is unfamiliar with the SQL syntax, it is preferred that the document management system automatically creates the command statement by presenting to the user the GUI (Graphical User Interface) such as the search request input display screen 110.

Next, the seed document acquisition unit 12 acquires the seed documents from the document database unit 14 or the external database 15 based on the command statements (6) and (7) created by the search request input unit 11 (S106). The sub-query in the above-mentioned example:

select title from Documents where ‘given attribute’ in . . . (6)

(select ‘given attributes’ from Documents where title contains ‘warming’ limit 10) . . . (7)

is transmitted to the document database unit 14. The documents that have the value of title item of any of the high-rank ten documents corresponding to the value of the given attribute among the documents which match the keyword ‘warming’ are acquired as the seed documents.

The command statements (6) and (7) in the case where the given attribute is an author (namely, when the documents which have the author common to that of the documents searched by the statement (7) are used as the seed documents) are as follows.

select title from Documents where ‘author ID’ in . . . (6)

(select ‘author ID’ from Documents where title contains ‘warming’ limit 10) . . . (7)

Moreover, the command statements (6) and (7) in the case where the given attribute is a publishing company (namely, when the documents which have a publishing company common to that of the documents searched by the statement (7) are used as the seed documents) are as follows.

select title from Documents where ‘publisher ID’ in . . . (6)

(select ‘publisher ID’ from Documents where title contains ‘warming’ limit 10)

Moreover, the command statements (6) and (7) in the case where the given attribute is a translator (namely, when the documents which have a translator common to that of the documents searched by the statement (7) are used as the seed documents) are as follows.

select title from Documents where ‘translator ID’ in . . . (6)

(select ‘translator ID’ from Documents where title contains ‘warming’ limit 10) . . . (7)

As described above, according to document management system 10 in the present embodiment, the extension words are chosen based on the character string (the seed acquisition character string) specified by the user, and it is possible to output high quality search results that are in conformity with the search request intended by the user.

Moreover, the seed acquisition character string can be input concurrently with the time of inputting of the search conditions, and the present embodiment enables the user to easily obtain high quality search results by performing a single search request operation.

Moreover, the documents which have a given attribute common to that of the documents searched based on the seed acquisition character string specified by the user are also used as the seed documents, and it is possible to enlarge the set of the seed documents for extracting the extension words, and it can be expected that the high quality search results that are in conformity with the demand of the user are obtained by using the extension words extracted from among the enlarged set of the seed documents.

It is conceivable that there is a tendency of publishing documents that are specialized in a specific genre and have a certain author, a publishing company, or a translator, etc. Therefore, it can be expected that the documents containing the given attribute as the common information that contains the source of each document, such as an author, a publishing company, or a translator, and that such documents function as effective seed documents.

In the above-mentioned example, the documents that have a given attribute common to that of the documents acquired based on the seed acquisition character string are also used as the seed documents. Alternatively, the documents that have a given attribute common to that of the documents acquired based on the search conditions may also be used as the seed documents.

The present invention is not limited to the above-described embodiments, and variations and modifications may be made without departing from the scope of the present invention.

What is claimed is:

1. A document searching device that searches documents from a set of predetermined documents in response to an input search condition, comprising:
a seed document acquiring unit to acquire seed documents based on information that is different from the input search condition;
a word extraction unit to extract a set of words that are associated with the input search condition, from the seed documents acquired by the seed document acquiring unit; and
a search unit to search documents from the set of predetermined documents based on the input search condition and the set of words extracted by the word extraction unit.

2. The document searching device according to claim 1 wherein the seed document acquiring unit is operable to acquire the seed documents based on a character string which is input separately from the input search condition.

3. The document searching device according to claim 2 wherein the seed document acquiring unit is operable to compute a frequency of occurrence in the character string of each of words which constitute the character string, and to acquire the seed documents based on a given number of words which are selected based on the frequency of occurrence of each word.

4. The document searching device according to claim 2 wherein the seed document acquiring unit is operable to acquire the seed documents from a set of documents that are different from the set of predetermined documents from which the search unit searches the documents.

5. The document searching device according to claim 2 wherein the seed document acquiring unit is operable to acquire second seed documents based on the character string and the set of words extracted from the seed documents acquired by the seed document acquiring unit,
the word extraction unit is operable to extract a set of words that are associated with the input search condition, from the second seed documents, and
the search unit is operable to search documents from the set of predetermined documents based on the input search condition and the set of words extracted from the second seed documents.

6. The document searching device according to claim 2 wherein the seed document acquiring unit is operable to acquire the seed documents that contain at least separately of the character string in bibliographic items of the seed documents.

7. The document searching device according to claim 1 wherein the seed document acquiring unit is operable to acquire additional seed documents that have a given attribute common to an attribute of seed documents acquired based on information different from the input search condition,
the word extraction unit is operable to extract a given number of words from the seed documents, based on a frequency of occurrence in the seed documents acquired by the seed document acquiring unit, and
the search unit is operable to search documents from the set of predetermined documents based on the input search condition and the given number of words extracted by the word extraction unit.

8. The document searching device according to claim 7 wherein the information different from the input search condition is either a character string searched from the set of predetermined documents based on the input search condition or a character string input separately from the input search condition.

9. The document searching device according to claim 7 wherein the given attribute is information that contains a source of each document.

10. A document searching method that is performed by a document searching device comprising a search unit searching documents from a set of predetermined documents in response to an input search condition, a seed document acquiring unit acquiring seed documents used for the search unit, and a word extraction unit to extract a set of words from the seed documents, the document searching method comprising:
the seed document acquiring unit acquiring seed documents based on information different from the input search condition;
the word extraction unit extracting a set of words that are associated with the input search condition, from the seed documents; and
the search unit searcing documents from the set of predetermined documents, based on the input search condition and the extracted set of words.

11. The document searching method according to claim 10 wherein acquiring seed documents comprises acquiring the seed documents based on a character string which is input separately from the input search condition.

12. The document searching method according to claim 11 wherein acquiring seed documents comprises computing a frequency of occurrence in the character string of each of words that constitute the character string, and acquiring the seed documents based on a given number of words which are selected based on the frequency of occurrence of each word.

13. The document searching method according to claim 11 wherein acquiring seed documents comprises acquiring the seed documents from a set of documents that are different from the set of predetermined documents from which the documents are searched in the search step.

14. The document searching method according to claim 11 wherein acquiring seed documents comprises acquiring second seed documents based on the character string and the extracted set of words,
wherein extracting the set of words comprises extracting a set of words which are associated with the input search condition, from the second seed documents, and
wherein searching documents comprises searching documents from the set of predetermined documents based on the input search condition and the set of words extracted from the second seed documents.

15. The document searching method according to claim 11 wherein acquiring seed documents comprises acquiring the seed documents that contain at least a part of the character string in bibliographic items of the seed documents.

16. The document searching method according to claim 10 wherein acquiring seed documents comprises acquiring additional seed documents that have a given attribute common to an attribute of seed documents acquired based on information different from the input search condition,
wherein extracting the set of words comprises extracting a given number of words from the seed documents, based on a frequency of occurrence in the seed documents, and
wherein searching documents comprises searching documents from the set of predetermined documents based on the input search condition and the given extracted number of words.

17. The document searching method according to claim 16 wherein the information different from the input search condition is either a character string searched from the set of predetermined documents based on the input search condition or a character string input separately from the input search condition.

18. The document searching method according to claim 16 wherein the given attribute is information which contains a source of each document.

19. A computer-readable recording medium storing a program embodied therein for causing a computer to execute the document searching method according to claim 10.
